(19) United States
(12) Patent Application Publication
(10) Pub. No.: US 2023/0006261 A1
(43) Pub. Date: Jan. 5, 2023

(54) ALL-SOLID-STATE BATTERY

(71) Applicant: TOYOTA JIDOSHA KABUSHIKI KAISHA, Toyota-shi (JP)

(72) Inventors: Takamasa OHTOMO, Miyoshi-shi (JP); Fuminori MIZUNO, Miyoshi-shi (JP); Shinya SHIOTANI, Nagoya-shi (JP)

(73) Assignee: TOYOTA JIDOSHA KABUSHIKI KAISHA, Toyota-shi (JP)

(21) Appl. No.: 17/836,254

(22) Filed: Jun. 9, 2022

(30) Foreign Application Priority Data
Jul. 2, 2021 (JP) 2021-110888

(51) Int. Cl. H01M 10/0585; H01M 50/126; H01M 10/0565; H01M 50/119; H01M 50/121; H01M 50/572

(52) U.S. Cl. CPC H01M 10/0585; H01M 50/126; H01M 10/0565; H01M 50/119; H01M 50/121; H01M 50/572

(57) ABSTRACT

To provide an all-solid-state battery that makes it possible to suppress short-circuiting due to a partially missing resin layer of a housing, in the all-solid-state battery formed of sealing an electrode structure in the housing, the housing is provided with a metal layer, the electrode structure includes an electrode stack and an outermost solid electrolyte layer, the electrode stack includes an outermost first current collector layer, the area of the outermost solid electrolyte layer is larger than the area of a flat plate part of the outermost first current collector layer in the stacking direction view, and the outermost solid electrolyte layer is stacked so as to entirely cover the flat plate part of the outermost first current collector layer.

### FIELD

This application relates to an all-solid-state battery.

### BACKGROUND

An all-solid-state battery using a solid electrolyte, instead of a non-aqueous electrolytic solution, has been developed in recent years for the improvement of its safety.

There are however some problems in the all-solid-state battery using a solid electrolyte. For example, the volume change due to charge and discharge causes the all-solid-state battery to be unstable in structure; and the solid electrolyte in the all-solid-state battery deteriorates because of its reaction with moisture in the air. The following techniques are known for dealing with such problems.

Patent Literature 1 discloses a technique on an all-solid-state battery that includes an electrode laminate having a resin layer arranged on its side surface, and that leads to an improvement of the adhesiveness between the electrode laminate and the resin layer. Patent Literature 2 discloses a technique on an all-solid-state battery including a housing and an electrode stack between which a solid electrolyte is arranged for the improvement of the strength. Patent Literature 3 discloses a technique on a fully-solid battery including electrode layers and solid electrolyte layers that have greater areas than the electrode layers, and that are disposed in a manner covering these electrode layers. Patent Literature 4 discloses a technique on an all-solid-state battery including an electrode stack that is entirely covered with resin layers for the improvement of moisture resistance. Patent Literature 5 discloses a technique on a bipolar type lithium ion battery including single cells that are stacked on each other via a sticky resin layer for the suppression of slippage.

### CITATION LIST

### Patent Literature

Patent Literature 1: JP 2019-192610 A
Patent Literature 2: JP 2014-235990 A
Patent Literature 3: JP 2018-142534 A
Patent Literature 4: WO 2014/007215 A1
Patent Literature 5: JP 2017-73374 A

### SUMMARY

### Technical Problem

A laminate housing formed by covering a metal layer with a resin layer is known as a housing of an all-solid-state battery. An all-solid-state battery is produced by sealing an electrode structure in such a housing.

When an all-solid-state battery is produced using a laminate housing, a conductive foreign object may be mixed in between the housing and a current collector layer or a tab part which is arranged on the outermost layer of an electrode structure. When such a conductive foreign object is present, stress may be concentrated on the conductive foreign object by outside pressure, thereby causing an inner resin layer of the laminate housing to be partially missing. Outside pressure may also cause stress to concentrate on (a) corner portion(s) of the current collector layer arranged on the outermost layer of the electrode structure, thereby causing the inner resin layer of the laminate housing to be partially missing. When the resin layer of the laminate housing is partially missing, the metal layer and the current collector layer in the housing are electrically connected to each other directly or via the conductive foreign object, thereby causing the battery to short-circuit, which is problematic. The all-solid-state battery may be stressed as described above not only after produced but also in thermocompression bonding for sealing the electrode structure in the laminate housing. Thus, it is an important problem in terms of the production of the all-solid-state battery and in terms of its safe use to suppress short-circuiting due to a partially missing inner resin layer of the laminate housing.

The main object of the present disclosure is to provide an all-solid-state battery that makes it possible to suppress short-circuiting due to a partially missing inner resin layer of a housing.

### Solution to Problem

As one way to solve the above problems, the present disclosure is provided with an all-solid-state battery formed of sealing an electrode structure in a housing, wherein the housing comprises an outer resin layer, an inner resin layer, and a metal layer disposed between the outer resin layer and the inner resin layer, the electrode structure comprises an electrode stack and an outermost solid electrolyte layer, the electrode stack comprises at least one electrode body including a first current collector layer, a first active material layer, a first solid electrolyte layer, a second active material layer, a second current collector layer, another second active material layer, a second solid electrolyte layer, another first active material layer, and another first current collector layer in this order, the first current collector layers and the second current collector layer each comprises an extending part and a flat plate part, one of the first current collector layers is arranged on at least one end portion of the electrode stack in a stacking direction, and when the first current collector layer arranged on at least one end portion of the electrode stack in the stacking direction is referred to as an outermost first current collector layer, the outermost solid electrolyte layer is stacked on a surface of the outermost first current collector layer on an opposite side of the first active material layers, an area of the outermost solid electrolyte layer is larger than an area of the flat plate part of the outermost first current collector layer in a stacking direction view, and the outermost solid electrolyte layer is stacked so as to entirely cover the flat plate part of the outermost first current collector layer in the stacking direction view.

In the all-solid-state battery, the outermost solid electrolyte layer may contain a polymer electrolyte.

The all-solid-state battery may have the following structure. That is, when the flat plate part of the outermost first current collector layer and the first active material layer, which are held between the outermost solid electrolyte layer and the first solid electrolyte layer, are referred to as a stack A in the electrode structure, at least one of the area of the outermost solid electrolyte layer and an area of the first solid electrolyte layer may be larger than that of the stack A in the stacking direction view, in the stacking direction view, at least one of the outermost solid electrolyte layer and the first solid electrolyte layer may be stacked so as to entirely cover the stack A, the stack A may be stored in the outermost solid electrolyte layer and the first solid electrolyte layer uniting along outer edges of the outermost solid electrolyte layer and the first solid electrolyte layer so that the outermost solid electrolyte layer and the first solid electrolyte layer can cover side faces of the stack A other than a side face where the extending part of the first current collector layer is disposed, and the extending part of the outermost first current collector layer may extend from the side face of the united outermost solid electrolyte layer and first solid electrolyte layer in the stacking direction view.

The all-solid-state battery may have the following structure. That is, when the second active material layers, and the flat plate part of the second current collector layer, which are held between the first solid electrolyte layer and the second solid electrolyte layer, are referred to as a stack B in the electrode body, at least one of the area of the first solid electrolyte layer and an area of the second solid electrolyte layer may be larger than that of the stack B in the stacking direction view, in the stacking direction view, at least one of the first solid electrolyte layer and the second solid electrolyte layer may be stacked so as to entirely cover the stack B, the stack B may be stored in the first solid electrolyte layer and the second solid electrolyte layer uniting along outer edges of the first solid electrolyte layer and the second solid electrolyte layer so that the first solid electrolyte layer and the second solid electrolyte layer can cover side faces of the stack B other than a side face where the extending part of the second current collector layer is disposed, and the extending part of the second current collector layer may extend from the side face of the united first solid electrolyte layer and second solid electrolyte layer in the stacking direction view.

The all-solid-state battery may have the following structure. That is, the electrode structure may comprise the electrode stack comprising a plurality of the stacked electrode bodies, the electrode bodies are connected so as to be parallel electrically, and when the first active material layers, and the flat plate parts of the first current collector layers, which are held between the second solid electrolyte layer of one of any adjacent two of the electrode bodies and the first solid electrolyte layer of another one of the adjacent two of the electrode bodies, are referred to as a stack C, the area of at least one of the second solid electrolyte layer and the first solid electrolyte layer of the two adjacent electrode bodies may be larger than that of the stack C in the stacking direction view, in the stacking direction view, at least one of the second solid electrolyte layer and the first solid electrolyte layer of the two adjacent electrode bodies may be stacked so as to cover the entire stack C, the stack C may be stored in the second solid electrolyte layer and the first solid electrolyte layer of the two adjacent electrode bodies uniting along outer edges of the second solid electrolyte layer and the first solid electrolyte layer of the two adjacent electrode bodies so that the second solid electrolyte layer and the first solid electrolyte layer of the two adjacent electrode bodies can cover side faces of the stack C other than a side face where the extending parts of the first current collector layers are disposed, and the extending part of at least one of the first current collector layers may extend from the side face of the united second solid electrolyte layer and first solid electrolyte layer of the two adjacent electrode bodies in the stacking direction view.

### Advantageous Effects

In the all-solid-state battery according to the present disclosure, the outermost solid electrolyte layer, which is an insulating layer, is arranged between the housing and the respective outermost first current collector layers. Thus, the presence of the outermost solid electrolyte layer makes it possible to suppress the metal layer of the housing and the outermost first current collector layers being in contact with each other even when a conductive foreign object is mixed in between the housing and the electrode structure during the production, stress is concentrated on the conductive foreign object by outside pressure, the inner resin layer of the housing is partially missing, and the metal layer is exposed.

In the all-solid-state battery according to the present disclosure, in the stacking direction view, the area of the outermost solid electrolyte layer is larger than the area of the flat plate part of each of the outermost first current collector layers, and also in the stacking direction view, the outermost solid electrolyte layer is stacked so as to cover the entire flat plate parts of the outermost first current collector layers. Thus, the presence of the outermost solid electrolyte layer makes it possible to suppress stress concentrating on the corner portions of the flat plate parts of the outermost first current collector layers even when pressure is applied from the outside. Therefore, it can be suppressed that the inner resin layer of the housing is partially missing due to stress concentrating on (a) corner portion(s) of the flat plate part(s) of the outermost first current collector layer(s).

For the above, the all-solid-state battery according to the present disclosure makes it possible to suppress short-circuiting due to a partially missing inner resin layer of the housing.

### BRIEF DESCRIPTION OF DRAWINGS

FIG. 1 is a schematic view of an all-solid-state-battery 1;

FIG. 2 is a perspective view of an electrode structure 20 taken out from the all-solid-state battery 1;

FIG. 3 is a cross-sectional view of the electrode structure 20 taken along of FIG. 2;

FIG. 4 is a schematic view of a cathode current collector layer 2111 in the stacking direction;

FIG. 5 is a schematic view of the electrode structure 20 observed in the V-direction in FIG. 2;

FIG. 6A is a schematic view of a side face of the electrode structure 20 which is observed in the VIa-direction in FIG. 2; FIG. 6B is a schematic view of a side face of the electrode structure 20 which is observed in the VIb-direction in FIG. 2; and FIG. 6C is a schematic view of a side face of the electrode structure 20 which is observed in the VIc direction in FIG. 2;

FIGS. 7A to 7D show one example of a method of preparing a baglike anode structure or a baglike cathode structure; and

FIG. 8 is a cross-sectional view of an electrode structure 1020 taken out from an all-solid-state battery of another aspect.

### DESCRIPTION OF EMBODIMENTS

An all-solid-state battery 1 according to one embodiment, and an all-solid-state battery according to another embodiment are used to describe the all-solid-state battery according to the present disclosure.

[All-Solid-State Battery 1]

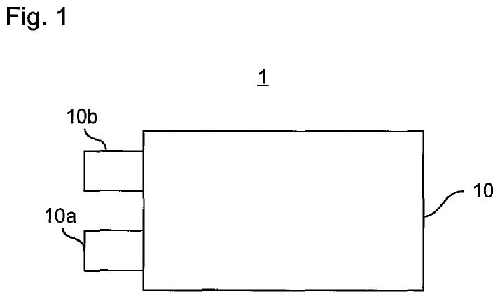

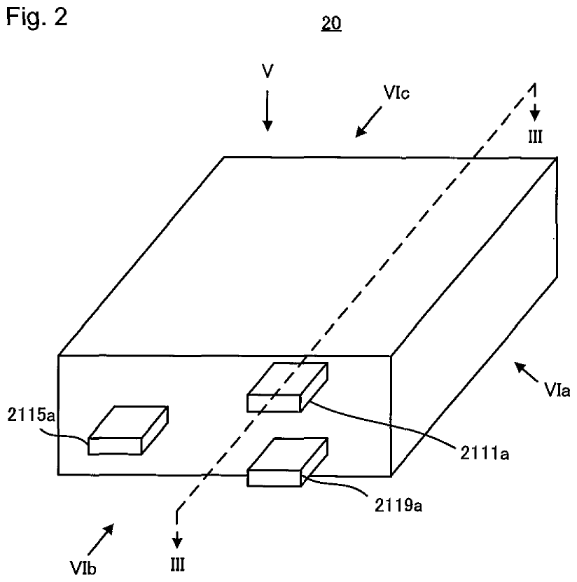

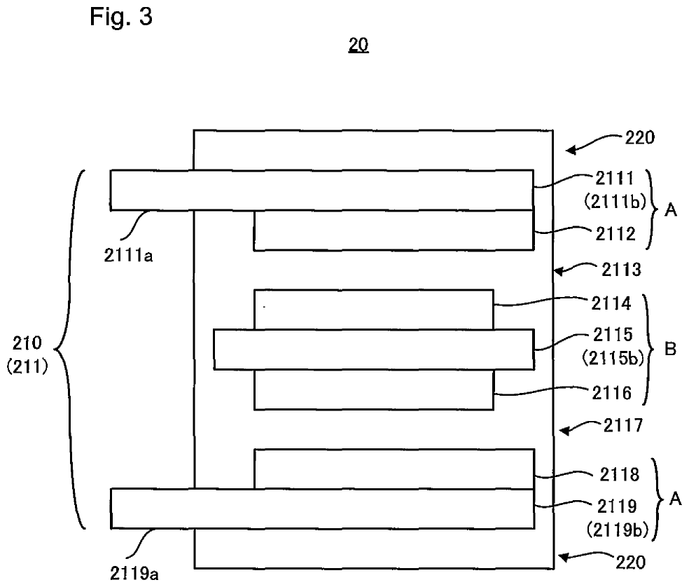

The all-solid-state battery 1 is formed by sealing an electrode structure 20 in a housing 10. FIG. 1 shows a schematic view of the all-solid-state-battery 1. FIG. 2 shows a perspective view of the electrode structure 20, which is taken out from the all-solid-state battery 1. FIG. 3 shows a cross-sectional view of the electrode structure 20 taken along III-III of FIG. 2.

<Housing 10>

The housing 10 is a laminate housing having a general insulating property. The housing 10 is formed of an outer resin layer, an inner resin layer, and a metal layer arranged between the outer resin layer and the inner resin layer. The housing according to the present disclosure is not limited to this, but may be formed of the foregoing layers and (an)other layer(s). For example, the housing according to the present disclosure may have a multilayer structure further including a resin layer etc. disposed therein.

The outer resin layer is a layer arranged on the outermost side of the housing 10. The outer resin layer is a layer for the improvement of durability. For example, PET (polyethylene terephthalate) is used as the material of the outer resin layer.

The inner resin layer is a layer arranged on the innermost side of the housing 10. The inner resin layer is a layer for allowing thermal welding to be performed. For example, a thermoplastic resin such as polypropylene (PP) is used as the material of the inner resin layer.

The metal layer is a layer arranged in an inner portion of the housing 10. As described above, the metal layer is arranged between the outer resin layer and the inner resin layer in the all-solid-state battery 1. The metal layer is a layer (gas barrier layer) for preventing moisture, air, and a gas generated inside the all-solid-state battery 1 from coming in and going out. The metal layer also reinforces the rigidity of the housing 10 for a function thereof. For example, aluminum or iron is used as the material of the metal layer.

<Electrode Structure 20>

As shown in FIG. 2, the electrode structure 20 is entirely covered with a solid electrolyte layer except for the extending parts of the current collector layers. There may be a portion where the solid electrolyte layer is not disposed on a side face of the electrode structure 20 that is on the side where the extending parts of the current collector layers are disposed in the all-solid-state battery according to the present disclosure.

As shown in FIG. 3, the electrode structure 20 includes an electrode stack 210, and an outermost solid electrolyte layer 220 stacked on both the end portions of the electrode stack 210 in the stacking direction. It is sufficient that the outermost solid electrolyte layer is stacked on at least one end portion of the electrode stack in the stacking direction in the all-solid-state battery according to the present disclosure.

(Electrode Stack 210)

The electrode stack 210 includes one electrode body 211. It is sufficient that the electrode stack includes at least one electrode body in the all-solid-state battery according to the present disclosure. An example of the all-solid-state battery that includes the electrode stack including a plurality of the electrode bodies will be described later.

(Electrode Body 211)

The electrode body 211 includes a cathode current collector layer (first current collector layer) 2111, a cathode active material layer (first active material layer) 2112, a first solid electrolyte layer 2113, an anode active material layer (second active material layer) 2114, an anode current collector layer (second current collector layer) 2115, an anode active material layer (second active material layer) 2116, a second solid electrolyte layer 2117, a cathode active material layer (first active material layer) 2118, and a first current collector layer (first current collector layer) 2119 in this order.

As described above, in the electrode body 211, the cathode current collector layer is referred to as the first current collector layer, the cathode active material layer is referred to as the first active material layer, the anode current collector layer is referred to as the second current collector layer, and the anode active material layer is referred to as the second active material layer. The all-solid-state battery according to the present disclosure is not limited to this, but the anode current collector layer may be referred to as the first current collector layer, the anode active material layer may be referred to as the first active material layer, the cathode current collector layer may be referred to as the second current collector layer, and the cathode active material layer may be referred to as the second active material layer.

(Cathode Current Collector Layers 2111 and 2119, and Anode Current Collector Layer 2115)

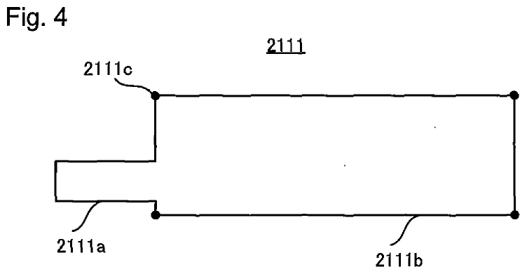

FIG. 4 shows a schematic view of the cathode current collector layer 2111 on the top side in the stacking direction. As shown in FIG. 4, the cathode current collector layer 2111 includes an extending part 2111a and a flat plate part 2111b. The extending part 2111a is a member extending from the side face of the electrode body 211, and is to be connected to a cathode terminal 1a directly or via a metal tab (not shown). The position of the extending part 2111a is not particularly limited, but may be suitably set according to the position where the cathode terminal 1a is arranged. The flat plate part 2111b is to be stacked on the electrode layer in the electrode body 211. The flat plate part 2111b has four corner portions 2111c because being rectangular. The cathode current collector layer 2119 has the same structure as the cathode current collector layer 2111. The anode current collector layer 2115 similarly includes an extending part 2115a and a flat plate part 2115b. The extending part 2115a of the anode current collector layer 2115 is to be connected to an anode terminal 1b directly or via a metal tab.

The extending parts of the cathode current collector layers 2111 and 2119 and the anode current collector layer 2115 extend from the same side face because the cathode terminal 1a and the anode terminal 1b are formed on the same side face in the all-solid-state battery 1. The all-solid-state battery according to the present disclosure is not limited to this, but the cathode terminal and the anode terminal may be formed on different side faces. In this case, the positions of the extending parts of the cathode current collector layers and the anode current collector layer may be suitably set according to the positions of the cathode and anode terminals, respectively.

As shown in FIG. 2, the cathode current collector layers 2111 and 2119 are arranged on both the end portions of the electrode stack 210 (electrode body 211) in the stacking direction. Hereinafter the cathode current collector layers 2111 and 2119 arranged on both the end portions of the electrode stack 210 in the stacking direction may be referred to as outermost cathode current collector layers 2111 and 2119. It is sufficient that the outermost cathode current collector layer (outermost first current collector layer) is arranged on at least one end portion of the electrode stack in the stacking direction in the all-solid-state battery according to the present disclosure.

Examples of the material of the cathode current collector layers include SUS, aluminum, nickel and carbon. For example, the cathode current collectors are in the form of foil. Examples of the material of the anode current collector layer include SUS, copper, nickel and carbon. For example, the anode current collector is in the form of foil. The cathode current collector layers and the anode current collector layer may be carbon-coated in a predetermined manner for the improvement of electric conductivity.

(Cathode Active Material Layers 2112 and 2118)

The cathode active material layers 2112 and 2118 may be cathode active material layers having the same or different composition(s). Hereinafter a cathode active material layer that may be used as them will be described.

The cathode active material layer contains a cathode active material. Examples of the cathode active material include oxide active materials. Examples of the oxide active materials include rock salt layered active materials such as LiCoO₂ and LiNi_{1/3}Co_{1/3}Mn_{1/3}O₂, spinel-type active materials such as LiMn₂O₄ and Li₄Ti₅O₁₂, and olivine-type active materials such as LiFePO₄. A protective layer containing a Li ion conducting oxide may be formed on the surface of the oxide active material because the reaction between the oxide active material and a solid electrolyte can be suppressed. An example of the Li ion conducting oxide is LiNbO₃. The thickness of the protective layer is, for example, 1 nm to 30 nm. For example, Li₂S may be used as the cathode active material. For example, the cathode active material is in a particulate form. The average particle diameter (D₅₀) of the cathode active material is not particularly limited, but for example, is at least 10 nm, and may be at least 100 nm. The average particle diameter (D₅₀) of the cathode active material is, for example, at most 50 μm, and may be at most 20 μm.

The content of the cathode active material in the cathode active material layer may be the same as the conventional content, and is, for example, in the range of 50-99 wt %.

For example, the average particle size (D₅₀) in the present disclosure can be calculated from the measurement using a laser diffraction particle size analyzer and/or a scanning electron microscope (SEM).

The cathode active material layer may optionally contain a conducting material. The addition of the conducting material improves the electronic conductivity of the anode layer. Examples of the conducting material include particulate carbonaceous materials such as acetylene black (AB) and Ketjenblack (KB), and fibrous carbon materials such as carbon fibers, carbon nanotubes (CNTs) and carbon nanofibers (CNFs). The content of the conducting material in the cathode active material layer may be the same as the conventional content, and is, for example, in the range of 0.1-10 wt %.

The cathode active material layer may optionally contain a binder. The addition of the binder causes the material constituting the cathode active material layer to be firmly bound to each other. Examples of the binder include fluoride-based binders, polyimide-based binders and rubber-based binders. The content of the binder in the cathode active material layer may be the same as the conventional content, and is, for example, in the range of 0.1-10 wt %.

The cathode active material layer may optionally contain a solid electrolyte. An inorganic solid electrolyte or a polymer electrolyte is a solid electrolyte that may be used in the cathode active material layer. A solid electrolyte preferably used in the cathode active material layer is an inorganic solid electrolyte having high ionic conductivity (particularly, a sulfide solid electrolyte).

Examples of the inorganic solid electrolyte include sulfide solid electrolytes, oxide solid electrolytes and halide solid electrolytes. The inorganic solid electrolyte may be a glass (amorphous solid), a glass-ceramic, or a crystal. For example, the glass is obtained by amorphizing a raw material. For example, the glass-ceramic is obtained by heat-treating a glass. For example, the crystal is obtained by heating a raw material.

For example, the sulfide solid electrolyte preferably contains Li, A (A is at least one of P, As, Sb, Si, Ge, Sn, B, Al, Ga and In) and S. The sulfide solid electrolyte may further contain at least one of O (oxygen) and a halogen. Examples of the halogen include F, Cl, Br and I. The sulfide solid electrolyte may contain one halogen only, or at least two halogens. When the sulfide solid electrolyte contains (an) anionic element(s) other than S (e.g., O and the halogen), the molar ratio of S is preferably the highest of all the anionic elements.

The sulfide solid electrolyte preferably has an anion structure in an ortho composition (PS₄³⁻ structure, SiS₄⁴⁻ structure, GeS₄⁴⁻ structure, AlS₃³⁻ structure or BS₃³⁻ structure) as the main component of the anion structures because chemical stability is high. For example, at least 50 mol %, optionally at least 60 mol % or at least 70 mol % of all the anion structures is the anion structure in an ortho composition in the sulfide solid electrolyte.

The sulfide solid electrolyte may have a crystalline phase having ionic conductivity. Examples of the crystalline phase include a Thio-LISICON type crystalline phase, a LGPS type crystalline phase and an argyrodite type crystalline phase.

For example, the oxide solid electrolyte preferably contains Li, Z (Z is at least one of Nb, B, Al, Si, P, Ti, Zr, Mo, W and S) and O. Specific examples of the oxide solid electrolyte include garnet type solid electrolytes such as Li₇La₃Zr₂O₁₂; perovskite type solid electrolytes such as (Li,La)TiO₃; NASICON type solid electrolytes such as Li(Al,Ti)(PO₄)₃; Li—P—O type solid electrolytes such as Li₃PO₄; and Li—B—O type solid electrolytes such as Li₃BO₃. When the oxide solid electrolyte contains (an) anionic element(s) other than O (e.g., S and a halogen), the molar ratio of O is preferably the highest of all the anionic elements.

The halide solid electrolyte is an electrolyte containing a halogen (X). Examples of the halogen include F, Cl, Br and I. Examples of the halide solid electrolyte include Li₃YX₆ (X is at least one of F, Cl, Br and I). When the halide solid electrolyte contains (an) anionic element(s) other than the halogen (e.g., S and O), the molar ratio of the halogen is preferably the highest of all the anionic elements.

For example, the inorganic solid electrolyte is in a particulate form. The average particle diameter (D₅₀) of the inorganic solid electrolyte is not particularly limited, but for example, is at least 10 nm, and may be at least 100 nm. The average particle diameter (D₅₀) of the inorganic solid electrolyte is, for example, at most 50 μm, and may be at most 20 μm.

The polymer electrolyte contains a polymer component. Examples of the polymer component include polyether-based polymers, polyester-based polymers, polyamine-based polymers and polysulfide-based polymers. Among them, polyether-based polymers are preferable because having high ionic conductivity, and being excellent in mechanical properties including Young's modulus and breaking strength.

The polyether-based polymer has a polyether structure in a repeating unit. The polyether-based polymer preferably has a polyether structure in the main chain of a repeating unit. Examples of the polyether structure include a polyethylene oxide (PEO) structure and a polypropylene oxide (PPO) structure. The polyether-based polymer preferably has a PEO structure as the major repeating unit. For example, at least 50 mol %, optionally at least 70 mol % or at least 90 mol % of all the repeating units is a PEO structure in the polyether-based polymer. For example, the polyether-based polymer may be a homopolymer or a copolymer of (an) epoxide(s) (such as ethylene oxide and propylene oxide).

The polymer component may have an ion conducting unit shown below. Examples of the ion conducting unit include polyethylene oxide, polypropylene oxide, polymethacrylate, polyacrylate, polydimethylsiloxane, polyacrylic acid, polymethacrylic acid, polyethylene vinyl acetate, polyimide, polyamine, polyamide, polyalkyl carbonate, polynitrile, polyphosphazene, polyolefin and polydiene.

The weight average molecular weight (Mw) of the polymer component is not particularly limited, but for example, is 1,000,000 to 10,000,000. Mw is obtained by gel permeation chromatography (GPC). The glass transition temperature (Tg) of the polymer component is, for example, at most 60° C., and may be at most 40° C., and may be at most 25° C. Only one type, or at least two types of the polymer component(s) may be used.

The polymer electrolyte may be a crosslinked polymer electrolyte including crosslinked polymer components, or an uncrosslinked polymer electrolyte including uncrosslinked polymer components. Examples of a polymerization initiator for cross-linking the polymer components include peroxides such as benzoyl peroxide, di-tert-butyl peroxide, tert-butyl benzoyl peroxide, tert-butyl peroxyoctoate, and cumene hydroperoxide; and azo compounds such as azobisisobutyronitrile.

The polymer electrolyte may be a dry polymer electrolyte, or a gel electrolyte. A dry polymer electrolyte is an electrolyte containing a 5 wt % solvent component or less. The content of the solvent component may be at most 3 wt % or at most 1 wt %.

The dry polymer electrolyte may contain a supporting electrolyte. Examples of the supporting electrolyte include inorganic lithium salts such as LiPF₆, LiBF₄, LiClO₄ and LiAsF₆, and organic lithium salts such as LiCF₃SO₃, LiN(CF₃SO₂)₂, LiN(C₂F₅SO₂)₂, LiN (FSO₂)₂ and LiC(CF₃SO₂)₃. The ratio of the supporting electrolyte to the dry polymer electrolyte is not particularly limited. For example, when having an EO unit (C₂H₄O unit), the dry polymer electrolyte has, for example, at least 5 parts by mole, and may have at least 10 parts by mole or at least 15 parts by mole of the EO unit per part by mole of the supporting electrolyte; and has, for example, at most 40 parts by mole, and may be at most 30 parts by mole of the EO unit per part by mole of the supporting electrolyte.

The gel electrolyte usually contains an electrolytic solution component in addition to the polymer component. The electrolytic solution component contains a supporting electrolyte and a solvent. The supporting electrolyte is the same as the above. Examples of the solvent include carbonates. Examples of the carbonates include cyclic esters (cyclic carbonates) such as ethylene carbonate (EC), propylene carbonate (PC) and butylene carbonate (BC); and chain esters (chain carbonates) such as dimethyl carbonate (DMC), diethyl carbonate (DEC) and ethyl methyl carbonate (EMC). Examples of the solvent also include acetates such as methyl acetate and ethyl acetate, and ethers such as 2-methyltetrahydrofuran. Examples of the solvent further include γ-butyrolactone, sulfolane, N-methylpyrrolidone (NMP) and 1,3-dimethyl-2-imidazolidinone (DMI). The solvent may be water.

The content of the solid electrolyte in the cathode active material layer may be the same as the conventional content, and is, for example, in the range of 1-50 wt %.

The thickness of the cathode active material layer is, for example, in the range of 0.1-1000 μm.

(Anode Active Material Layers 2114 and 2116)

The anode active material layers 2114 and 2116 may be anode active material layers having the same or different composition(s). Hereinafter an anode active material layer that may be used as them will be described.

The anode active material layer contains an anode active material. Examples of the anode active material include metal active materials such as Si, Sn and Li; carbon active materials such as graphite; and oxide active materials such as lithium titanate. The anode active material may be a Si-based active material containing at least Si. Examples of the Si-based active material include elemental Si, Si alloys and Si oxides. The Si alloy preferably contains a Si element as the main component. For example, at least 50 at %, optionally at least 70 at % or at least 90 at % of the Si alloy is Si.

For example, the anode active material is in a particulate form. The average particle diameter (D₅₀) of the anode active material is, for example, at least 10 nm, and may be at least 100 nm. The average particle diameter (D₅₀) of the anode active material is, for example, at most 50 μm, and may be at most 20 μm.

The content of the anode active material in the anode active material layer may be the same as the conventional content, and is, for example, in the range of 20-99 wt %.

The anode active material layer may optionally contain a conducting material, a binder or a solid electrolyte. The description of the conducting material, the binder and the solid electrolyte is omitted here because being the same as described above. When the anode active material layer contains the solid electrolyte, the polymer electrolyte is preferably used as the solid electrolyte. When a sulfide solid electrolyte highly reactive to a polar solvent is used in the cathode, the dry polymer electrolyte is preferable.

The thickness of the anode active material layer is, for example, in the range of 0.1-1000 μm. The area of the anode active material layer may be larger than the cathode active material layer in terms of suppression of Li dendrites.

(First Solid Electrolyte Layer 2113, Second Solid Electrolyte Layer 2117 and Outermost Solid Electrolyte Layer 220)

The first solid electrolyte layer 2113, the second solid electrolyte layer 2117 and the outermost solid electrolyte layer 220 may be solid electrolyte layers having the same or different composition(s). Hereinafter a solid electrolyte layer that may be used as them will be described.

The solid electrolyte layer contains a solid electrolyte. The solid electrolyte used in the solid electrolyte layer is the same as the above. When the solid electrolyte layer contains the inorganic solid electrolyte, the content of the inorganic solid electrolyte in the solid electrolyte layer is not particularly limited, but is, for example, in the range of 50-100 wt %. When containing the inorganic solid electrolyte, the solid electrolyte layer may optionally contain a binder. The binder used in the solid electrolyte layer is the same as the above. The content of the binder in the solid electrolyte layer is not particularly limited, but is, for example, in the range of 0.1-10 wt %.

When the solid electrolyte layer contains a polymer electrolyte, a crosslinked polymer electrolyte is preferably used as the polymer electrolyte. The solid electrolyte layer containing the polymer electrolyte is preferably a free-standing layer. “Free-standing” means that the shape can be kept without any other supports. For example, such a solid electrolyte layer can be said to be a “free-standing” layer when the shape thereof is kept after being put on a substrate and thereafter the substrate is peeled off. At least 50 vol %, optionally at least 70 vol % or at least 90 vol % of the solid electrolyte layer is the polymer electrolyte. The solid electrolyte layer may contain the polymer electrolyte only.

The thickness of the solid electrolyte layer is, for example, in the range of 0.1-1000 μm.

(Structure of Electrode Structure 20)

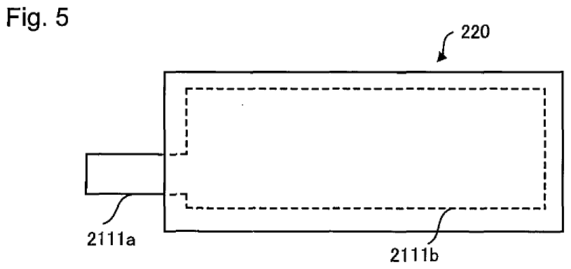

(1) FIG. 5 shows a schematic view of the electrode structure 20 observed in the V-direction (on the upper side of the stacking direction) in FIG. 2. The dotted line in FIG. 5 represents the outermost cathode current collector layer 2111, to which the electrode structure 20 is looked through. As shown in FIGS. 3 and 5, the outermost solid electrolyte layer 220 is stacked on a surface of the outermost cathode current collector layer 2111 which is on the opposite side of the cathode active material layer 2112. Such arrangement of the outermost solid electrolyte layer 220 results in the outermost solid electrolyte layer 220, which is an insulating layer, present between the housing 10 and the outermost cathode current collector layer 2111. Thus, the presence of the outermost solid electrolyte layer 220 makes it possible to suppress the metal layer of the housing 10 and the outermost cathode current collector layer 2111 being in contact with each other, and the short-circuiting of the all-solid-state battery 1 even when a conductive foreign object is mixed in between the housing 10 and the electrode structure 20 during the production of the all-solid-state battery 1, thereafter stress is concentrated on the conductive foreign object by outside pressure, the inner resin layer of the housing 10 is partially missing, and the metal layer is exposed.

As shown in FIG. 5, the area of the outermost solid electrolyte layer 220 is larger than the area of the flat plate part 2111b of the outermost cathode current collector layer 2111 in the stacking direction view. The outermost solid electrolyte layer 220 is stacked so as to cover the entire flat plate part 2111b of the outermost cathode current collector layer 2111 in the stacking direction view. In other words, the outer edge of the outermost solid electrolyte layer 220 is formed larger than the outer edge of the flat plate part 2111b of the outermost cathode current collector layer 2111. Thus, the presence of the outermost solid electrolyte layer 220 makes it possible to suppress stress concentrating on the corner portions 2111c of the flat plate part 2111b of the outermost cathode current collector layer 2111 even when pressure is applied from the outside. In other words, it can be suppressed that the inner resin layer of the housing 10 is partially missing due to stress concentrating on the corner portion(s) 2111c of the flat plate part 2111b, and that the all-solid-state battery 1 short-circuits.

The outermost solid electrolyte layer 220 containing the polymer electrolyte improves the effect of suppressing short-circuiting. The electrode stack 210 (electrode body 211) expands and shrinks according to charge and discharge. In particular, when a Si or Sn-based alloy anode active material is used as the anode active material, the volume more largely changes. The use of the inorganic solid electrolyte in the outermost solid electrolyte layer 220 in such a case may make it impossible for the outermost solid electrolyte layer 220 to reach the volume change in the electrode stack 210 due to charge and discharge, which causes cracking and slips. In particular, stress concentrating on the corner portions 2111c of the flat plate part 2111b may cause the internal resin layer of the housing 10 to be partially missing since the ends stretch more largely and thus tend to crack. When the outermost solid electrolyte layer 220 contains the polymer electrolyte having high flexibility, the outermost solid electrolyte layer 220 can reach the volume change in the electrode stack 210 due to charge and discharge, which leads to suppression of cracking.

Needless to say, the above description (1) is also applied to the cathode active material layer 2118, the outermost cathode current collector layer 2119 and the outermost solid electrolyte layer 220, which are arranged in the electrode structure 20 on the lower side in the stacking direction.

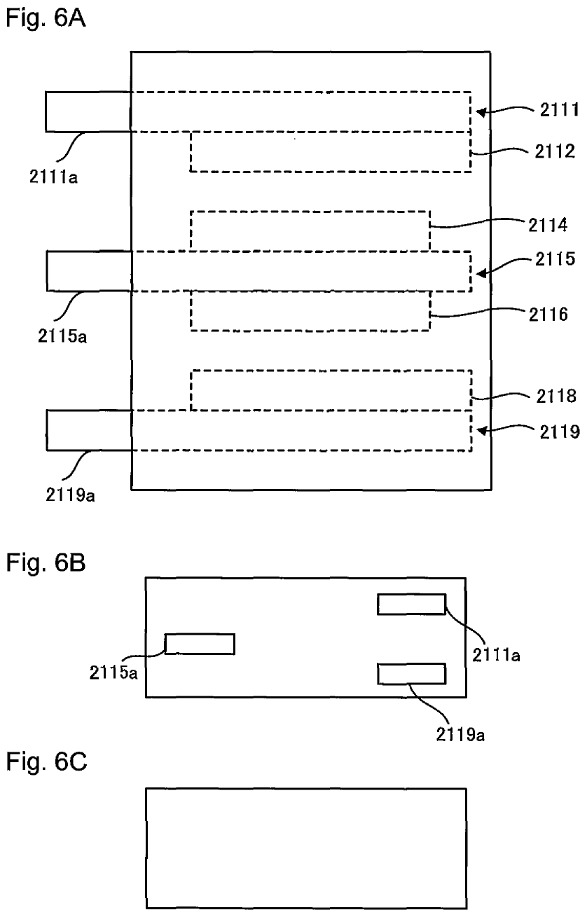

(2) FIG. 6A shows a schematic view of a side face of the electrode structure 20 which is observed in the VIa-direction in FIG. 2. FIG. 6B shows a schematic view of the side face of the electrode structure 20, which is observed in the VIb-direction in FIG. 2. FIG. 6C shows a schematic view of a side face of the electrode structure 20 which is observed in the VIc direction in FIG. 2. The dotted line shown in FIG. 6A represents the electrode layers other than the solid electrolyte layers, to which the electrode structure 20 is looked through. Here, as shown in FIG. 3, in the electrode structure 20, the flat plate part 2111b of the outermost cathode current collector layer 2111, and the cathode active material layer 2112, which are held between the outermost solid electrolyte layer 220 and the first solid electrolyte layer 2113, are referred to as a stack A.

As can be seen from FIGS. 2, 3, 5 and 6A to 6C, the areas of the outermost solid electrolyte layer 220 and the first solid electrolyte layer 2113 are each larger than that of the stack A in the stacking direction view, and also in the stacking direction view, the outermost solid electrolyte layer 220 and the first solid electrolyte layer 2113 are each stacked so as to cover the entire stack A, and the stack A is stored in the outermost solid electrolyte layer 220 and the first solid electrolyte layer 2113 uniting along their outer edges so that the outermost solid electrolyte layer 220 and the first solid electrolyte layer 2113 can cover the entire side surface (except the extending part) of the stack A. The extending part 2111a of the outermost cathode current collector layer 2111 extends from the side face of the united outermost solid electrolyte layer 220 and first solid electrolyte layer 2113 in the stacking direction view.

In the all-solid-state battery according to the present disclosure, the area of at least one of the outermost solid electrolyte layer and the first solid electrolyte layer may be larger than that of the stack A in the stacking direction view, and also in the stacking direction view, at least one of the outermost solid electrolyte layer and the first solid electrolyte layer may be stacked so as to cover the entire stack A, and the stack A may be stored in the outermost solid electrolyte layer and the first solid electrolyte layer uniting along their outer edges so that the outermost solid electrolyte layer and the first solid electrolyte layer can cover the side faces other than the side face where the extending part of the first current collector layer of the stack A is arranged.

The stack A is stored in the outermost solid electrolyte layer 220 and the first solid electrolyte layer 2113 united on all over the side surface of the stack A as described above, which can prevent the stack A and a stack B (the anode active material layers and the anode current collector layer) described later from short-circuiting. The outermost solid electrolyte layer 220 and the first solid electrolyte layer 2113 contain the polymer electrolyte, which makes it possible to unite the outermost solid electrolyte layer 220 and the first solid electrolyte layer 2113 on the side surface of the stack A by chemical crosslinking in the polymer electrolyte through UV or heat treatment, and to suppress slippage in stacking. Even when the above described uniting by chemical crosslinking is not performed, the solid electrolyte layers can be united only by just bringing the solid electrolyte layers into contact with each other because the solid electrolyte layer containing the polymer electrolyte has adhesion.

The outermost solid electrolyte layer 220 and the first solid electrolyte layer 2113 are united on and only the extending part 2111a is extended from the side face of the stack A, where the extending part 2111a of the outermost cathode current collector layer 2111 extends, which makes it possible to suppress short-circuiting caused by the extending part 2115a of the anode current collector layer 2115 coming into contact with the flat plate part 2111b of the outermost cathode current collector layer 2111 or the cathode active material layer 2112.

It is not always necessary to unite the outermost solid electrolyte layer 220 and the first solid electrolyte layer 2113 on the side face of the stack A, where the extending part 2111a of the outermost cathode current collector layer 2111 extends, in the all-solid-state battery according to the present disclosure. In other words, the outermost solid electrolyte layer 220 and the first solid electrolyte layer 2113 may be united on just the side faces of the stack A other than the side face where the extending part 2111a of the outermost cathode current collector layer 2111 extends. In such a case, the extending part 2111a of the outermost cathode current collector layer 2111 may be coated with, for example, an insulating resin on a place where the extending part 2115b of the anode current collector layer 2115 may be in contact with.

Needless to say, the above description (2) is also applied to the second solid electrolyte layer 2117, the cathode active material layer 2118, the outermost cathode current collector layer 2119 and the outermost solid electrolyte layer 220, which are arranged in the electrode structure 20 on the lower side in the stacking direction.

(3) The structure of the electrode structure 20 will be further described with reference to FIGS. 2, 3, 5 and 6A to 6C. As shown in FIG. 3, in the electrode body 211, the anode active material layer 2114, the flat plate part 2115b of the anode current collector layer 2115, and the anode active material layer 2116, which are held between the first solid electrolyte layer 2113 and the second solid electrolyte layer 2117, are referred to as the stack B.

As can be seen from FIGS. 2, 3, 5 and 6A to 6C, the areas of the first solid electrolyte layer 2113 and the second solid electrolyte layer 2117 are each larger than that of the stack B in the stacking direction view, and also in the stacking direction view, the first solid electrolyte layer 2113 and the second solid electrolyte layer 2117 are each stacked so as to cover the entire stack B, and the stack B is stored in the first solid electrolyte layer 2113 and the second solid electrolyte layer 2117 uniting along their outer edges so that the first solid electrolyte layer 2113 and the second solid electrolyte layer 2117 can cover the entire side surface (except the extending part) of the stack B. The extending part 2115a of the anode current collector layer 2115 extends from the side face of the united first solid electrolyte layer 2113 and second solid electrolyte layer 2117 in the stacking direction view.

In the all-solid-state battery according to the present disclosure, the area of at least one of the first solid electrolyte layer and the second solid electrolyte layer may be larger than that of the stack B in the stacking direction view, and also in the stacking direction view, at least one of the first solid electrolyte layer and the second solid electrolyte layer may be stacked so as to cover the entire stack B, and the stack B may be stored in the first solid electrolyte layer and the second solid electrolyte layer uniting along their outer edges so that the first solid electrolyte layer and the second solid electrolyte layer can cover the side faces other than the side face where the extending part of the second current collector layer of the stack B is arranged.

The stack B is stored in the first solid electrolytic layer 2113 and the second solid electrolyte layer 2117 united on all over the side surface of the stack B as described above, which makes it possible to suppress slips due to cracking in the anode layer which is caused when a Si or Sn-based alloy anode active material is used as the anode active material. The first solid electrolytic layer 2113 and the second solid electrolyte layer 2117 contain the polymer electrolyte, which makes it possible to unite the first solid electrolytic layer 2113 and the second solid electrolyte layer 2117 on the side surface of the stack B by chemical crosslinking in the polymer electrolyte through UV or heat treatment, and to suppress slippage in stacking. Even when the above described uniting by chemical crosslinking is not performed, the solid electrolyte layers can be united only by just bringing the solid electrolyte layers into contact with each other because the solid electrolyte layer containing the polymer electrolyte has adhesion. Further, when the outermost solid electrolyte layer 220, the first solid electrolyte layer 2113 and the second solid electrolyte layer 2117 contain the polymer electrolyte, the first solid electrolyte layer 2113 is divided into two layers of an upper layer and a lower layer, the outermost solid electrolyte layer 220 and the upper layer of the first solid electrolyte layer 2113 are united, and the lower layer of the first solid electrolyte layer 2113 and the second solid electrolyte layer 2117 are united, slippage in stacking the united structures can be suppressed.

The first solid electrolyte layer 2113 and the second solid electrolyte layer 2117 are united on and only the extending part 2115a is extended from the side face of the stack B, where the extending part 2115a of the anode current collector layer 2115 extends, which makes it possible to suppress short-circuiting caused by the extending part(s) 2111a and/or 2119a of the cathode current collector layers 2111 and 2119 coming into contact with the flat plate part 2115b of the anode current collector layer 2115, or the anode active material layer 2114 or 2116.

It is not always necessary to unite the first solid electrolyte layer 2113 and the second solid electrolyte layer 2117 on the side face of the stack B, where the extending part 2115a of the anode current collector layer 2115 extends, in the all-solid-state battery according to the present disclosure. In other words, the first solid electrolyte layer 2113 and the second solid electrolyte layer 2117 may be united on just the side faces of the stack B other than the side face where the extending part 2115a of the anode current collector layer 2115 extends. In such a case, the extending part 2115a of the anode current collector layer 2115 may be coated with, for example, an insulating resin on places where the extending parts of the cathode current collector layers 2111 and 2119 may be in contact with.

The following problems can be also solved by uniting the first solid electrolyte layer 2113 and the second solid electrolyte layer 2117, which contain the polymer electrolyte. Conventionally, when a solid electrolyte such as a sulfide solid electrolyte is used in an anode active material layer and a solid electrolyte layer, the interface of the anode active material layer and the solid electrolyte layer peels off and/or cracks and the inside of the solid electrolyte layer cracks due to the expansion and/or shrinkage of an anode active material according to charge and discharge, which is problematic. In order to solve such a problem, the present inventors thought of the use of a polymer electrolyte having high flexibility as the solid electrolyte. They however found that when a polymer electrolyte is used in the anode active material layer and the area of the anode active material layer is made to be larger than a cathode active material layer, pressing for joining the electrode layers causes the electrode stack to warp, and different kinds of the electrodes are in contact with each other and short-circuit, which is also problematic. To solve this, the present inventors further researched and found that, as described above, the first solid electrolyte layer 2113 and the second solid electrolyte layer 2117 containing the polymer electrolyte are united, which makes it possible to suppress different kinds of the electrodes coming into contact with each other by pressing for joining the electrodes. Accordingly, the first solid electrolyte layer 2113 and the second solid electrolyte layer 2117 containing the polymer electrolyte are united, which makes it possible to solve the above-described problems on production, to suppress cracking of the electrodes due to the volume change according to charge and discharge, and to improve the cycle characteristics of the all-solid-state battery 1.

[All-Solid-State Battery of Another Aspect]

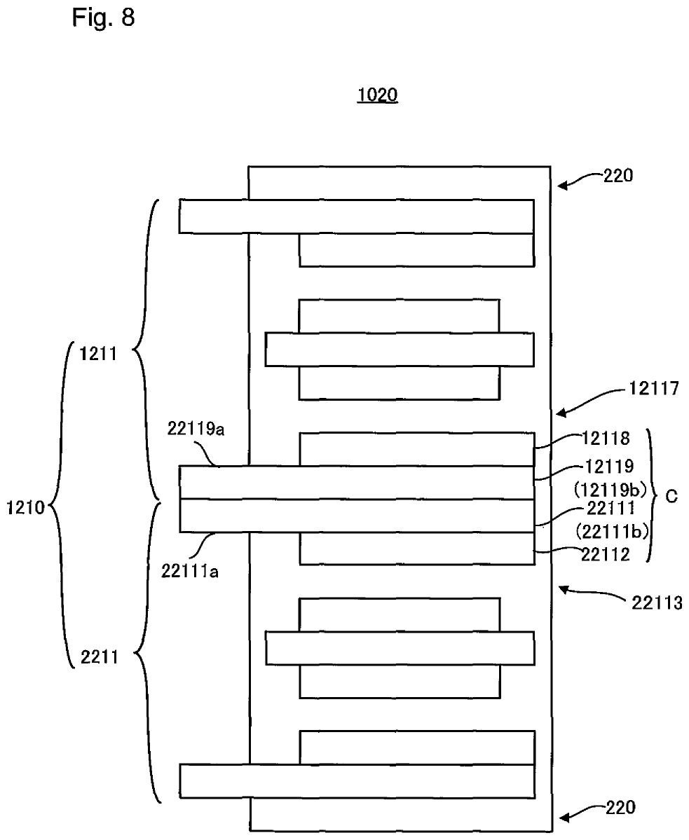

Instead of the electrode structure 20 of the all-solid-state battery 1, an electrode structure 1020 including an electrode stack 1210 formed by stacking a plurality of electrode bodies 1211 and 2211 is used in an all-solid-state battery of another aspect. The description on the structure except the electrode structure 1020 will be omitted below because the structure except the electrode structure 1020 is the same as the all-solid-state battery 1. FIG. 8 corresponds to FIG. 2, and shows a schematically cross-sectional view of the electrode structure 1020 taken out from the all-solid-state battery of the other aspect.

As shown in FIG. 8, the electrode structure 1020 of an all-solid-state battery 2 includes the electrode stack 1210 formed by stacking the two electrode bodies 1211 and 2211. The electrode bodies 1211 and 2211 are connected so as to be parallel electrically. Specifically, the electrode bodies 1211 and 2211, which are adjacent to each other, are stacked so that a cathode current collector layer 12119 of the electrode body 1211 and a cathode current collector layer 22111 of the electrode body 2211 are in contact with each other.

Here, a cathode active material layer 12118 of the electrode body 1211, a flat plate part 12119b of the cathode current collector layer 12119 of the electrode body 1211, a flat plate part 22111b of the cathode current collector layer 22111 of the electrode body 2211, and a cathode active material layer 22112 of the electrode body 2211 which are held between a second solid electrolyte layer 12117 of the electrode body 1211 and a first solid electrolyte layer 22113 of the electrode body 2211 (hereinafter may be referred to as “adjacent solid electrolyte layers”) are referred to as a stack C.

The areas of the adjacent solid electrolyte layers are each larger than that of the stack C in the stacking direction view, and also in the stacking direction view, the adjacent solid electrolyte layers are each stacked so as to cover the entire stack C, and the stack C is stored in the adjacent solid electrolyte layers uniting along their outer edges so that the adjacent solid electrolyte layers can cover the entire side surface (except the extending parts) of the stack C. The extending parts 12119a and 22111a of the cathode current collector layers 12119 and 22111 extend from the side face of the united adjacent solid electrolyte layers in the stacking direction view.

In the all-solid-state battery according to the present disclosure, the area of at least one of the second solid electrolyte layer of one of any two adjacent electrode bodies and the first solid electrolyte layer of the other one of the adjacent electrode bodies may be larger than that of the stack C in the stacking direction view, and also in the stacking direction view, at least one of the second solid electrolyte layer and the first solid electrolyte layer of the adjacent electrode bodies may be stacked so as to cover the entire stack C, and the stack C may be stored in the second solid electrolyte layer and the first solid electrolyte layer of the adjacent electrode bodies uniting along their outer edges so that the second solid electrolyte layer and the first solid electrolyte layer of the adjacent electrode bodies can cover the side faces other than the side face where the extending parts of the first current collector layers of the stack C is arranged. It is sufficient that the extending part of at least one of the cathode current collector layers (first current collector layers) extends from the side face of the united adjacent solid electrolyte layers in the all-solid-state battery according to the present disclosure.

The stack C is stored in the adjacent solid electrolyte layers, which are united on all over the side surface of the stack C as described above, which makes it possible to suppress slippage in stacking these layers. The adjacent solid electrolyte layers contain the polymer electrolyte, which makes it possible to unite the adjacent solid electrolyte layers on the side surface by chemical crosslinking in the polymer electrolyte through UV or heat treatment, and further to suppress slippage in stacking. Even when the above described uniting by chemical crosslinking is not performed, the solid electrolyte layers can be united only by just bringing the solid electrolyte layers into contact with each other because the solid electrolyte layer containing the polymer electrolyte has adhesion.

The adjacent solid electrolyte layers are united on and the extending parts 12119a and 22111a are extended from the side face of the stack C, where the extending parts 12119a and 22111a of the cathode current collector layers 12119 and 22111 extend, which makes it possible to suppress short-circuiting caused by the extending parts of the anode current collector layers coming into contact with the flat plate part(s) 12119a and/or 22111a of the cathode current collector layers 12119 and 22111, or the cathode active material layer 12118 or 22112.

It is not always necessary to unite the adjacent solid electrolyte layers on the side face of the stack C, where the extending parts of the cathode current collector layers extend, in the all-solid-state battery according to the present disclosure. In other words, the adjacent solid electrolyte layers may be united on just the side faces of the stack C other than the side face, where the extending parts of the cathode current collector layers extend. In such a case, the extending parts of the cathode current collector layers may be coated with, for example, an insulating resin on places where the extending parts of the anode current collector layers may be in contact with.

[Method of Producing All-Solid-State Battery]

The method of producing the all-solid-state battery according to the present disclosure is not particularly limited. For example, the all-solid-state battery may be produced as follows.

First, a slurry is prepared by mixing and kneading the material to constitute the cathode active material layer, and a dispersion medium. A coating is formed by coating the cathode current collector layer or a substrate with the obtained slurry, and thereafter removing the dispersion medium by drying. Then, the cathode active material layer is formed by pressing and densifying the coating. One may peel off the substrate and stick the cathode current collector layer after the pressing. According to this, the cathode structure having a cathode current collector and the cathode active material layer on one surface of the cathode current collector is prepared. The anode structure having an anode current collector and the anode active material layers on both the surfaces of the anode current collector are prepared in the same manner.

Next, when the inorganic solid electrolyte is used as the solid electrolyte, the solid electrolyte layer may be prepared in the same manner as described above. In other words, a slurry is prepared by mixing and kneading the material to constitute the solid electrolyte layer, and a dispersion medium. A coating is formed by coating a substrate with the obtained slurry, and thereafter removing the dispersion medium by drying. Then, the solid electrolyte layer is formed by pressing and densifying the coating.

When the polymer electrolyte is used as the solid electrolyte, for example, the solid electrolyte layer may be prepared as follows. That is, a homogeneous polymer electrolytic solution is prepared by mixing and kneading the material to constitute the solid electrolyte layer, the polymerization initiator, and a solvent. A substrate is coated with the obtained slurry. Thereafter the solvent is removed by drying, and at the same time a polymerization reaction is started. According to this, the solid electrolyte layer containing a crosslinked polymer electrolyte that includes crosslinked polymer components is prepared on the substrate.

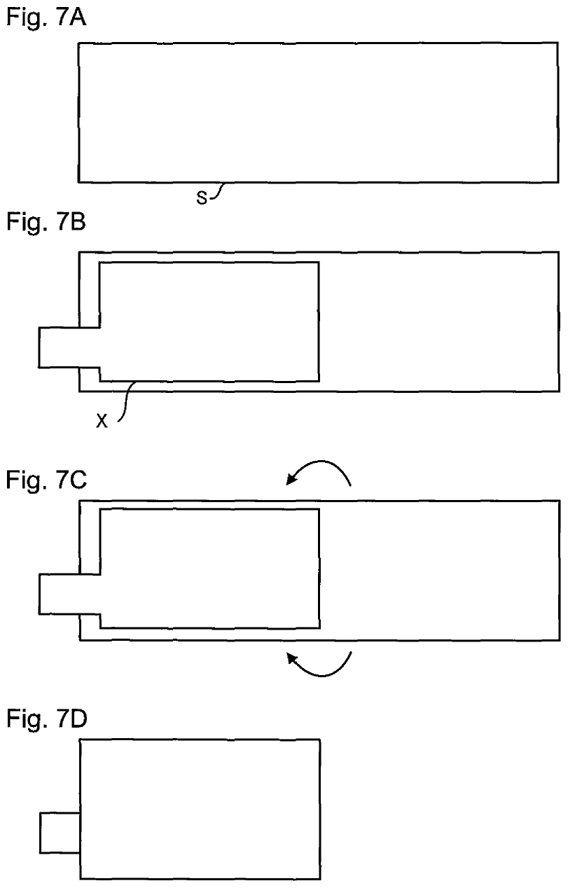

The solid electrolyte layer may be a baglike solid electrolyte having a space for storing some electrode layers thereinside. The baglike solid electrolyte may be prepared as follows. FIGS. 7A to 7D show the steps of preparing the baglike solid electrolyte. First, as in FIG. 7A, a solid electrolyte (S) is put. Next, as in FIG. 7B, an anode structure having the anode active material layers on both the surfaces thereof, or a cathode structure having the cathode active material layer on one surface thereof (X) which is to be the inside of the solid electrolyte is put. Then, as in FIG. 7C, the solid electrolyte is bent. Lastly, as in FIG. 7D, the anode structure or the cathode structure stored in the baglike solid electrolyte (a baglike anode structure or a baglike cathode structure) can be prepared by sticking the outer edge of the solid electrolyte. In the above steps, one may put a release sheet of, e.g., a PET film instead of the anode structure or the cathode structure, prepare the baglike solid electrolyte, and thereafter insert the anode structure or the cathode structure into the inside. In the above description, the baglike solid electrolyte is prepared by folding the solid electrolyte double. The present disclosure is not limited to this. One may also make two solid electrolytes hold the anode structure or the cathode structure therebetween, and stick the outer edges of the two solid electrolytes, thereby preparing the baglike solid electrolyte.

Here, one may prepare the solid electrolyte layer according to the present disclosure so that the area thereof will be larger than that of each of the other electrode layers in order to unite the solid electrolyte layers on the side surface of the stack after stacking the electrode layers.

Lastly, the prepared electrode layers are stacked, and the obtained electrode structure is wrapped by laminate.

For example, the electrode layers are stacked in a predetermined order, and pressed. Subsequently, the solid electrolyte layers are united on the side surface of the stack except for a case where the solid electrolyte layers are united on the side surface of the stack by pressing. Then, a cathode terminal and an anode terminal are attached to the obtained electrode structure, and the resultant is stored in the laminate housing, and sealed in the laminate housing by thermal welding. According to this, the all-solid-state battery is obtained.

An example of using the baglike solid electrolyte will be also described below. First, a case where the all-solid-state battery including one electrode body is produced will be described.

The electrode structure is obtained by stacking the baglike cathode structures on both the surfaces of the baglike anode structure, and press-molding and uniting the baglike cathode and anode structures. Alternatively, the baglike cathode structures are stacked on both the surfaces of the anode structure, and the baglike cathode structures and the anode structure are press-molded and united. Subsequently, the electrode structure is obtained by bringing the outer edges of the upper and lower baglike cathode structures into contact with each other and uniting the upper and lower baglike cathode structures so that the baglike cathode structures can cover the side faces other than the side face where the extending part of the anode current collector layer is disposed. A cathode terminal and an anode terminal are attached to the obtained electrode structure, and the resultant is stored in the laminate housing, and sealed in the laminate housing by thermal welding. According to this, the all-solid-state battery is obtained.

Next, a case where the all-solid-state battery including a plurality of the electrode bodies is produced will be described.

Each of the electrode bodies is obtained by stacking the baglike cathode structure, the baglike anode structure and the cathode structure in this order. Then, the two electrode bodies are stacked so that the cathode current collector layers can be in contact with each other. Subsequently, the outer edges of the upper and lower baglike anode structures are brought into contact with each other and the upper and lower baglike anode structures are united so that the upper and lower baglike anode structures can cover the side faces other than the side face where the extending parts of the cathode current collector layers are disposed. According to this, the electrode structure is obtained.

Alternatively, a baglike cathode structure (2) formed by storing the two cathode structures, which are arranged so that the cathode current collector layers can be in contact with each other, in the baglike solid electrolyte is prepared. Then, the baglike cathode structure, the baglike anode structure, the baglike cathode structure (2), the baglike anode structure and the baglike cathode structure are stacked in this order, press-molded, and united. According to this, the electrode structure is obtained.

A cathode terminal and an anode terminal are attached to the obtained electrode structure, and the resultant is stored in the laminate housing, and sealed in the laminate housing by thermal welding. According to this, the all-solid-state battery is obtained.

Alternatively, a first electrode body is obtained by stacking the baglike cathode structure, the anode structure and the cathode structure in this order. A second electrode body is obtained by stacking the cathode structure, the baglike anode structure and the cathode structure in this order. Then, the first electrode body, the second electrode body and the first electrode body are stacked in this order so that the cathode current collector layers can be in contact with each other. Subsequently, the outer edges of the upper and lower baglike cathode structures and the baglike anode structure are brought into contact with each other and the upper and lower baglike cathode structures and the baglike anode structure are united so that the upper and lower baglike cathode structures and the baglike anode structure can cover the side faces other than the side face where the extending parts of the cathode and anode current collector layers are disposed. According to this, the electrode structure is obtained. A cathode terminal and an anode terminal are attached to the obtained electrode structure, and the resultant is stored in the laminate housing, and sealed in the laminate housing by thermal welding. According to this, the all-solid-state battery is obtained.

### EXAMPLES

Hereinafter the all-solid-state battery according to the present disclosure will be further described based on Examples.

[Preparing All-Solid-State Battery]

### Example 1

### (Preparing Anode Structure)

An anode active material (Si particle, average particle diameter: 2.5 μm), a conducting material (VGCF-H: vapor grown carbon fiber) and a binder (PVdF-HFP: polyvinylidene fluoride-hexafluoropropylene) were weighed so as to have the following weight ratio: anode active material:conducting material:binder=94:4:2, and was mixed with a dispersion medium (diisobutyl ketone). An anode slurry was obtained by dispersing the obtained mixture by means of an ultrasonic homogenizer (UH-50 manufactured by SMT Corporation). An anode current collector layer (Ni foil, thickness: 15 μm) was coated with the obtained anode slurry by a blade coating method with an applicator, and dried at 100° C. for 30 minutes. Thereafter, an anode structure intermediate that included an anode current collector layer having an anode active material layer on both the surfaces of the anode current collector layer was obtained by coating, in the same manner, a surface of the anode current collector layer which is on the opposite side of the surface where the coating had been already performed.

PEO (polyethylene oxide, Mw: approximately 4,000,000) and LiTFSI (LiN(SO₂CF₃)₂) were weighed so as to have the following molar ratio: EO unit:Li=20:1, and mixed with acetonitrile, thereafter stirred until the resultant became a homogeneous solution. One surface of the anode structure intermediate was coated with the obtained PEO-LiTFSI solution by a blade coating method with an applicator, and dried at 100° C. for 60 minutes. Thereafter an anode structure was obtained by coating the other surface of the anode structure intermediate with the PEO-LiTFSI solution in the same manner. After the drying, the gap of the blade was adjusted's° that the weight ratio of the anode active material to the polymer electrolyte could be 68:32. Thereafter an anode stack including the anode current collector layer, and the anode active material layers disposed on both the surfaces of the anode current collector layer was obtained by pressing, thereby densifying the anode structure intermediate.

(Preparing Cathode Structure)

A cathode active material (LiNi_{0.8}CO_{0.15}Al_{0.05}O₂, average particle diameter: 10 μm) coated with LiNbO₃ by means of a tumbling fluidized bed granulating-coating machine, a sulfide solid electrolyte (10LiI.15LiBr.75(0.75Li₂S.0.25P₂S₅) (mol %), average particle diameter: 0.5 μm), a conducting material (VGCF-H) and a binder (SBR: styrene-butadiene rubber) were weighed so as to have the following weight ratio: cathode active material:sulfide solid electrolyte:conducting material:binder=85:13:1:1, and mixed with a dispersion medium (diisobutyl ketone). A cathode slurry was obtained by dispersing the obtained mixture by means of an ultrasonic homogenizer (UH-50 manufactured by SMT Corporation). A cathode structure having a cathode layer and an Al foil was obtained by coating the Al foil (thickness: 15 μm) with the obtained cathode slurry by a blade coating method with an applicator, drying the resultant at 100° C. for 30 minutes, and pressing thereby densifying the resultant.

(Preparing Solid Electrolyte Layer)

PEO (polyethylene oxide, Mw: approximately 4,000,000) and LiTFSI (LiN(SO₂CF₃)₂) were weighed so as to have the following molar ratio: EO/unit:Li=20:1, and mixed with acetonitrile. An initiator BPO (benzoyl peroxide) was mixed with the obtained solution so as to be 10 wt % of PEO-LiTFSI, thereafter stirred until the resultant became a homogeneous solution. A solid electrolyte layer containing a polymer electrolyte was obtained by coating a PET film with the prepared polymer electrolytic solution by a blade coating method with an applicator so that the width of the polymer electrolytic solution would be 7.4 cm, and drying the resultant at 100° C. for 60 minutes, thereafter cutting the resultant so that the resultant would have a length of 14.2 cm.

(Preparing All-Solid-State Battery)

A baglike cathode structure was obtained by sticking the cathode structure cut out so that the cathode active material layer would have a size of 7.0 cm×7.0 cm, and the solid electrolyte layer to each other so that the cathode structure and the solid electrolyte layer could be in direct contact with each other, and the central portion of an end face of the cathode current collector layer which was opposite to a side where an extending part was disposed could be at the same position as the respective central portions of the end faces of the solid electrolyte layer, and bending the solid electrolyte layer in the long side direction. Subsequently, the baglike cathode structures were sticked to both the surfaces of the anode stack cut out so as to have a size of 7.0 cm×7.0 cm, so as to be in direct contact with the anode stack on the cathode active material layers sides, and the resultant was pressed at 0.5 t/cm². Then, an all-solid-state battery according to Example 1 was obtained by welding each terminal, thereafter sealing the electrode structure in a laminate housing formed of an Al metal layer.

### Example 2

The anode structure, the cathode structure and the solid electrolyte layer were prepared in the same manner as in Example 1.

(Preparing All-Solid-State Battery)

A baglike cathode structure was obtained by sticking the cathode structure cut out so that the cathode active material layer would have a size of 7.0 cm×7.0 cm, and the solid electrolyte layer to each other so that the cathode structure and the solid electrolyte layer could be in direct contact with each other, and the central portion of an end face of the cathode current collector layer which was opposite to a side where an extending part was disposed could be at the same position as the respective central portions of the end faces of the solid electrolyte layer, and bending the solid electrolyte layer in the long side direction. Subsequently, a first electrode body was obtained by sticking the baglike cathode structure to one surface of the anode stack cut out so that the anode active material layer would have a size of 7.0 cm×7.0 cm, so that the baglike cathode structure could be in direct contact with the anode stack on the cathode active material layer side, and sticking another baglike cathode structure to the other surface of the anode stack so that the baglike cathode structure could be in direct contact with the anode stack on the cathode active material layer side, thereafter pressing the resultant at 0.5 t/cm².

A baglike anode structure was obtained by sticking the anode stack cut out so that the anode active material layer would have a size of 7.0 cm×7.0 cm, and the solid electrolyte layer to each other so that the anode stack and the solid electrolyte layer could be in direct contact with each other, and the central portion of an end face of the anode current collector layer which was opposite to a side where an extending part was disposed could be at the same position as the respective central portions of the end faces of the solid electrolyte layer, and bending the solid electrolyte layer in the long side direction. Subsequently, a second electrode body was obtained by sticking the cathode structures each cut out so that the cathode active material layer would have a size of 7.0 cm×7.0 cm to both the surfaces of the baglike anode structure so that the cathode active material layers and the solid electrolyte layer could be in direct contact with each other, thereafter pressing the resultant at 0.5 t/cm².

The first electrode bodies were stacked on both the surfaces of the second electrode body so that the cathode current collector layers could be in direct contact with each other. Subsequently, the electrodes are fixed to each other by joining the outer edges of the three baglike solid electrolytes on the side faces other than the side face where the extending parts of the current collector layers were disposed. Then, an all-solid-state battery according to Example 2 was obtained by welding each terminal, thereafter sealing the electrode structure in a laminate housing formed of an Al metal layer.

### Comparative Example 1

The anode structure, the cathode structure and the solid electrolyte layer were prepared in the same manner as in Example 1.

(Preparing All-Solid-State Battery)

The solid electrolyte layer cut out so as to have a size of 7.2 cm×7.2 cm was stuck to both the surfaces of the anode structure cut out so that the anode active material layer would have a size of 7.2 cm×7.2 cm, so as to be in direct contact with the anode active material layer and so that end faces where an extending part was disposed were flush. An electrode body was obtained by sticking the cathode structures each cut out so that the cathode active material layer would have a size of 7.0 cm×7.0 cm to both the surfaces of the obtained stack so that the cathode active material layers and the solid electrolyte layers were in direct contact with each other, and pressing the resultant at 0.5 t/cm². Then, an all-solid-state battery according to comparative example 1 was obtained by welding each terminal, thereafter sealing the electrode body in a laminate housing formed of an Al metal layer.

### Comparative Example 2

An all-solid-state battery according to comparative example 2 was obtained by stacking the three electrode bodies each of which was the same as obtained in comparative example 1, and welding each terminal, thereafter sealing the electrode bodies in a laminate housing formed of an Al metal layer.

### Evaluation

A welded portion of the laminate housing of each of the obtained all-solid-state batteries were shaved off and the Al metal layer was exposed. The Al metal layer to the respective terminals voltages were measured with a tester, and the ratio of short-circuiting via the laminate housing was evaluated. If the measured voltage was 0 V, it was determined that a short circuit occurred. If the measured voltage was higher than 0 V, it was determined that no short circuit occurred. The number of the tested all-solid-state batteries was ten for each example. The results are shown below.

Example 1: short-circuiting ratio 0/10
Example 2: short-circuiting ratio 0/10
Comparative example 1: short-circuiting ratio 2/10
Comparative example 2: short-circuiting ratio 4/10

From the above results, it was found that the all-solid-state batteries according to examples 1 and 2, which used electrode structures each having an outermost solid electrolyte layer, could prevent short-circuiting via the laminate housings. The all-solid-state batteries according to comparative examples 1 and 2, which used electrode structures each having no outermost solid electrolyte layer, could not prevent short-circuiting via the laminate housings.

### INDUSTRIAL APPLICABILITY

The all-solid-state battery according to the present disclosure is typically an all-solid-state lithium ion secondary battery. The all-solid-state battery is used without any particular limitations, but for example, used as a power source for an automobile such as a hybrid electric vehicle (HEV), a battery electric vehicle (BEV), a gasoline vehicle and a diesel vehicle. In particular, the all-solid-state battery is preferably used as a power source for driving a hybrid electric vehicle or a battery electric vehicle. The all-solid-state battery according to the present disclosure may be used as a power supply for any mobile body other than the automobile (such as a railway vehicle, a ship and an aircraft), and may be used as a power source for an electrical product such as information processing equipment.

### REFERENCE SIGNS LIST

1 all-solid-state battery
10 housing
20 electrode structure
210 electrode stack
211 electrode body
2111 cathode current collector layer (first current collector layer)
2112 cathode active material layer (first active material layer)
2113 first solid electrolyte layer
2114 anode active material layer (second active material layer)
2115 anode current collector layer (second current collector layer)
2116 anode active material layer (second active material layer)
2117 second solid electrolyte layer
2118 cathode current collector layer (first current collector layer)
2119 cathode active material layer (first active material layer)
220 outermost solid electrolyte layer
1020 electrode structure
1210 electrode stack
1211 electrode body
2211 electrode body
12117 second solid electrolyte layer
12118 cathode active material layer (first active material layer)
12119 cathode current collector layer (first current collector layer)
22111 cathode current collector layer (first current collector layer)
22112 cathode active material layer (first active material layer)
22113 first solid electrolyte layer

What is claimed is:

1. An all-solid-state battery formed of sealing an electrode structure in a housing, wherein
the housing comprises an outer resin layer, an inner resin layer, and a metal layer disposed between the outer resin layer and the inner resin layer,
the electrode structure comprises an electrode stack and an outermost solid electrolyte layer,
the electrode stack comprises at least one electrode body including a first current collector layer, a first active material layer, a first solid electrolyte layer, a second active material layer, a second current collector layer, another second active material layer, a second solid electrolyte layer, another first active material layer, and another first current collector layer in an order mentioned,
the first current collector layers and the second current collector layer each comprises an extending part and a flat plate part,
one of the first current collector layers is arranged on at least one end portion of the electrode stack in a stacking direction, and
when the first current collector layer arranged on at least one end portion of the electrode stack in the stacking direction is referred to as an outermost first current collector layer,
the outermost solid electrolyte layer is stacked on a surface of the outermost first current collector layer on an opposite side of the first active material layers,
an area of the outermost solid electrolyte layer is larger than an area of the flat plate part of the outermost first current collector layer in a stacking direction view, and
the outermost solid electrolyte layer is stacked so as to entirely cover the flat plate part of the outermost first current collector layer in the stacking direction view.

2. The all-solid-state battery according to claim 1, wherein the outermost solid electrolyte layer contains a polymer electrolyte.

3. The all-solid-state battery according to claim 1, wherein
when the flat plate part of the outermost first current collector layer and the first active material layer, which are held between the outermost solid electrolyte layer and the first solid electrolyte layer, are referred to as a stack A in the electrode structure,
at least one of the area of the outermost solid electrolyte layer and an area of the first solid electrolyte layer is larger than that of the stack A in the stacking direction view,
in the stacking direction view, at least one of the outermost solid electrolyte layer and the first solid electrolyte layer is stacked so as to entirely cover the stack A,
the stack A is stored in the outermost solid electrolyte layer and the first solid electrolyte layer uniting along outer edges of the outermost solid electrolyte layer and the first solid electrolyte layer so that the outermost solid electrolyte layer and the first solid electrolyte layer can cover side faces of the stack A other than a side face where the extending part of the first current collector layer is disposed, and
the extending part of the outermost first current collector layer extends from the side face of the united outermost solid electrolyte layer and first solid electrolyte layer in the stacking direction view.

4. The all-solid-state battery according to claim 1, wherein
when the second active material layers, and the flat plate part of the second current collector layer, which are held between the first solid electrolyte layer and the second solid electrolyte layer, are referred to as a stack B in the electrode body,
at least one of the area of the first solid electrolyte layer and an area of the second solid electrolyte layer is larger than that of the stack B in the stacking direction view,
in the stacking direction view, at least one of the first solid electrolyte layer and the second solid electrolyte layer is stacked so as to entirely cover the stack B,
the stack B is stored in the first solid electrolyte layer and the second solid electrolyte layer uniting along outer edges of the first solid electrolyte layer and the second solid electrolyte layer so that the first solid electrolyte layer and the second solid electrolyte layer can cover side faces of the stack B other than a side face where the extending part of the second current collector layer is disposed, and
the extending part of the second current collector layer extends from the side face of the united first solid electrolyte layer and second solid electrolyte layer in the stacking direction view.

5. The all-solid-state battery according to claim 1, wherein
the electrode structure comprises the electrode stack comprising a plurality of the stacked electrode bodies,
the electrode bodies are connected so as to be parallel electrically, and
when the first active material layers, and the flat plate parts of the first current collector layers, which are held between the second solid electrolyte layer of one of any adjacent two of the electrode bodies and the first solid electrolyte layer of another one of the adjacent two of the electrode bodies, are referred to as a stack C,
the area of at least one of the second solid electrolyte layer and the first solid electrolyte layer of the two adjacent electrode bodies is larger than that of the stack C in the stacking direction view,
in the stacking direction view, at least one of the second solid electrolyte layer and the first solid electrolyte layer of the two adjacent electrode bodies is stacked so as to cover the entire stack C,
the stack C is stored in the second solid electrolyte layer and the first solid electrolyte layer of the two adjacent electrode bodies uniting along outer edges of the second solid electrolyte layer and the first solid electrolyte layer of the two adjacent electrode bodies so that the second solid electrolyte layer and the first solid electrolyte layer of the two adjacent electrode bodies can cover side faces of the stack C other than a side face where the extending parts of the first current collector layers are disposed, and
the extending part of at least one of the first current collector layers extends from the side face of the united second solid electrolyte layer and first solid electrolyte layer of the two adjacent electrode bodies in the stacking direction view.
